(19) United States
(12) Patent Application Publication
(10) Pub. No.: US 2018/0181307 A1
(43) Pub. Date: Jun. 28, 2018

(54) INFORMATION PROCESSING DEVICE, CONTROL DEVICE AND METHOD

(71) Applicant: FUJITSU LIMITED, Kawasaki-shi (JP)

(72) Inventor: Kazuichi Oe, Yokohama (JP)

(73) Assignee: FUJITSU LIMITED, Kawasaki-shi (JP)

(21) Appl. No.: 15/825,163

(22) Filed: Nov. 29, 2017

(30) Foreign Application Priority Data
Dec. 27, 2016 (JP) 2016-252801

(51) Int. Cl. G06F 3/06

(52) U.S. Cl. CPC G06F 3/0605; G06F 3/0649; G06F 3/067; G06F 3/0665; G06F 3/0653

(57) ABSTRACT

An information processing device includes a first memory, a second memory and a processor coupled to the first memory and the second memory, the processor being configured to obtain access information about a number of times of data accesses including write accesses and read accesses, the data accesses being made to the first memory from another information processing device, perform processing of migration of data between the first memory and the second memory, and stop execution of the processing of the migration of the data from the second memory to the first memory when the number of times of data accesses per unit time is more than a first value and a ratio of the write accesses to the data accesses is less than a second value.

### CROSS-REFERENCE TO RELATED APPLICATION

This application is based upon and claims the benefit of priority of the prior Japanese Patent Application No. 2016-252801, filed on Dec. 27, 2016, the entire contents of which are incorporated herein by reference.

### FIELD

The embodiments discussed herein are related to an information processing device, a control device, and a method.

### BACKGROUND

A hierarchical storage system in which a plurality of storage media (storage devices) are combined together may be used as a storage system that stores data. The plurality of storage media include, for example, a solid state drive (SSD), which is capable of high-speed access but has a relatively low capacity and is high-priced, and a hard disk drive (HDD), which has a high capacity and is low-priced but has a relatively low speed.

In the hierarchical storage system, the data of a storage region with low access frequency is disposed in the storage device with low access speed, while the data of a storage region with high access frequency is disposed in the storage device with high access speed. It is thereby possible to enhance usage efficiency of the storage device with high access speed, and enhance the performance of the system as a whole.

Thus moving data between a storage region of one storage device and a storage region of another storage device in the hierarchical storage system may be referred to as migration.

In addition, a hierarchical storage device has recently been proposed which includes an SSD and a dual inline memory module (DIMM) as storage devices. Related art documents include International Publication Pamphlet No. WO 2012/169027 and Japanese Laid-open Patent Publication No. 2015-179425.

### SUMMARY

According to an aspect of the embodiments, an information processing device includes a first memory, a second memory and a processor coupled to the first memory and the second memory, the processor being configured to obtain access information about a number of times of data accesses including write accesses and read accesses, the data accesses being made to the first memory from another information processing device, perform processing of migration of data between the first memory and the second memory, and stop execution of the processing of the migration of the data from the second memory to the first memory when the number of times of data accesses per unit time is more than a first value and a ratio of the write accesses to the data accesses is less than a second value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a storage system including a hierarchical storage device as an example of an embodiment;

FIG. 2 is a diagram illustrating a functional configuration of a hierarchical storage device as an example of an embodiment;

FIG. 3 is a diagram of assistance in explaining IO accesses to an SSD in a hierarchical storage device as an example of an embodiment;

FIG. 4 is a diagram illustrating relation between the number of IO accesses, a write ratio, and execution/withholding of data movement in a hierarchical storage device as an example of an embodiment;

FIG. 5 is a diagram illustrating a hardware configuration of a hierarchical storage control device illustrated in FIG. 2;

FIG. 6 is a flowchart of assistance in explaining processing by a hierarchical managing unit of a hierarchical storage device as an example of an embodiment; and

FIG. 7 is a flowchart of assistance in explaining threshold value update processing in a hierarchical storage device as an example of an embodiment.

### DESCRIPTION OF EMBODIMENTS

An SSD includes a semiconductor element memory, which is a nonvolatile memory, as a storage medium. It is known that when writing is performed in large quantities to a nonvolatile memory to which input output (IO) access is being made mainly for reading, IO access response time is slowed significantly.

For example, when data of another storage device included in a hierarchical storage device is migrated to an SSD, write access for writing the data to be migrated occurs in the SSD.

Hence, when write access due to migration as described above is made to the SSD to which read and write data access is made from a higher-level device such as a host device, a decrease in response speed of the SSD occurs, and the access performance of the hierarchical storage device is decreased.

In the following, referring to the drawings, description will be made of embodiments of an information processing device, a storage control program, and a storage control method. However, the embodiments to be illustrated in the following are illustrative only, and are not intended to exclude the application of various modifications and technologies not explicitly illustrated in the embodiments. For example, the present embodiments may be modified in various manners and carried out without departing from the spirit of the embodiments. In addition, each figure is not intended to include only constituent elements illustrated in the figure, but may include other functions.

[1] Configuration

[1-1] Example of Configuration of Storage System

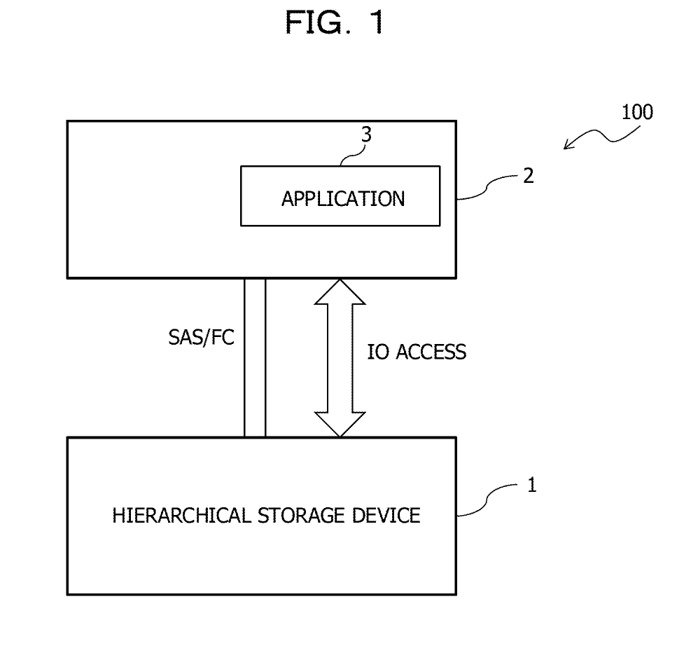

FIG. 1 is a diagram illustrating a configuration of a storage system 100 including a hierarchical storage device 1 as an example of an embodiment.

As illustrated in FIG. 1, the storage system 100 includes a host device 2 such as a personal computer (PC) and the hierarchical storage device 1. The host device 2 and the hierarchical storage device 1 are coupled to each other via an interface such as a serial attached small computer system interface (SAS), or a fibre channel (FC).

The host device 2 includes a processor such as a central processing unit (CPU), which is not illustrated. The host device 2 implements various functions by executing an application 3 by the processor.

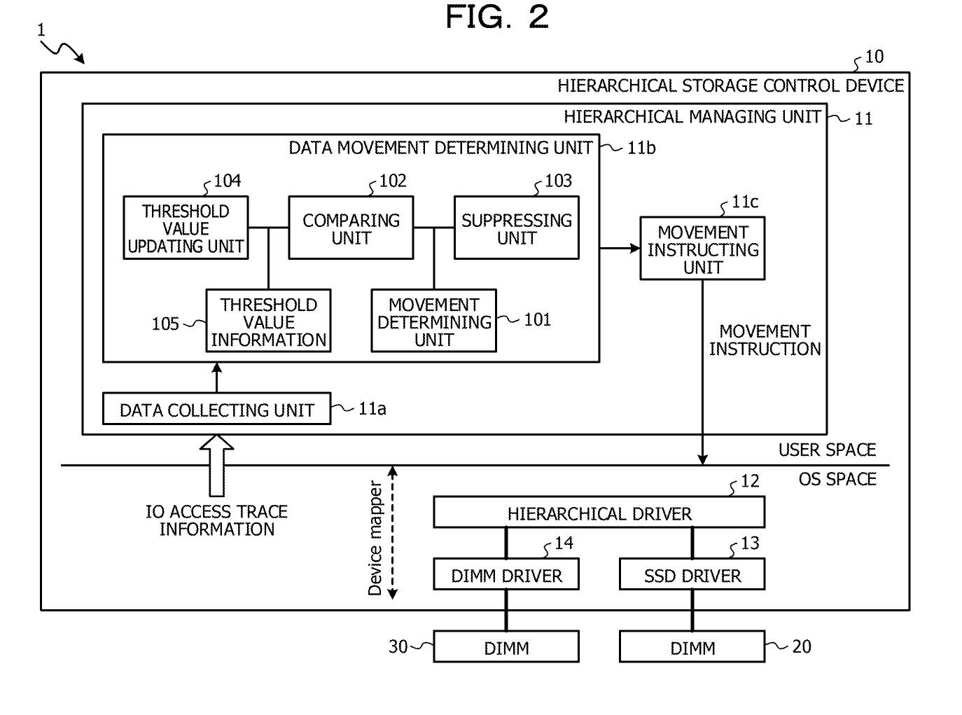

As will be described later, the hierarchical storage device 1 includes a plurality of kinds of storage devices (an SSD 20 and a DIMM 30 in an example illustrated in FIG. 2), and provides the storage regions of these storage devices to the host device 2. The storage regions provided by the hierarchical storage device 1 store data generated by the execution of the application 3 in the host device 2 and data or the like used to execute the application 3.

An IO access (data access) occurs when the host device 2 makes an IO access request (data access request) for writing or reading data to the storage regions of the hierarchical storage device 1.

[1-2] Example of Functional Configuration of Hierarchical Storage Device

FIG. 2 is a diagram illustrating a functional configuration of the hierarchical storage device 1 as an example of an embodiment. As illustrated in FIG. 2, the hierarchical storage device (storage device) 1 includes a hierarchical storage control device (storage control device) 10, an SSD 20, and a DIMM 30.

The hierarchical storage control device 10 is a storage control device that makes various data accesses to the SSD 20 and the DIMM 30 in response to IO access requests from the host device 2 as a higher-level device. For example, the hierarchical storage control device 10 makes data access for a read, a write, or the like to the SSD 20 and the DIMM 30. The hierarchical storage control device 10 includes information processing devices such as a PC, a server, or a controller module (CM).

In addition, the hierarchical storage control device 10 according to the present embodiment implements dynamic hierarchical control that disposes a region with low access frequency in the SSD 20, while disposing a region with high access frequency in the DIMM 30, according to IO access frequency.

The SSD (first storage device) 20 is a semiconductor drive device including a semiconductor element memory, and is an example of a storage device storing various data, programs, and the like. The DIMM (second storage device) 30 is an example of a storage device having different performance from (for example, having higher speed than) the SSD 20. A semiconductor drive device such as the SSD 20 and a semiconductor memory module such as the DIMM 30 are cited as examples of storage devices different from each other (that may hereinafter be written as a first storage device and a second storage device for convenience) in the present embodiment. However, there is no limitation to this. It suffices to use various storage devices having performances different from each other (for example, having read/write speeds different from each other) as the first and second storage devices.

The SSD 20 and the DIMM 30 constitute storage volumes in the hierarchical storage device 1.

One storage volume recognized from the host device 2 or the like will hereinafter be referred to as a logical unit number (LUN). Further, one unit (unit region) obtained by dividing the LUN in a size determined in advance is referred to as a sub-LUN. Incidentally, the size of the sub-LUN may be changed as appropriate on the order of megabytes (MBs) to gigabytes (GBs), for example. Incidentally, the sub-LUN may be referred to as a segment.

Each of the SSD 20 and the DIMM 30 includes a storage region capable of storing data of a sub-LUN (unit region) on the storage volume. The hierarchical storage control device 10 controls region movement between the SSD 20 and the DIMM 30 in sub-LUN units. The movement of data between the storage region of the SSD 20 and the storage region of the DIMM 30 may hereinafter be referred to as migration.

It is to be noted that the hierarchical storage device 1 in FIG. 1 is assumed to include one SSD 20 and one DIMM 30, but is not limited to this. The hierarchical storage device 1 may include a plurality of SSDs 20 and a plurality of DIMMs 30.

Details of the hierarchical storage control device 10 will next be described.

As illustrated in FIG. 2, as an example, the hierarchical storage control device 10 includes a hierarchical managing unit 11, a hierarchical driver 12, an SSD driver 13, and a DIMM driver 14. Incidentally, for example, the hierarchical managing unit 11 is implemented as a program executed in a user space, and the hierarchical driver 12, the SSD driver 13, and the DIMM driver 14 are implemented as a program executed in an operating system (OS) space.

Suppose in the present embodiment that the hierarchical storage control device 10, for example, uses functions of a Linux (registered trademark) device-mapper. The device-mapper monitors the storage volumes in sub-LUN units, and processes IO to a high-load region by moving the data of a sub-LUN with a high load from the SSD 20 to the DIMM 30. Incidentally, the device-mapper is implemented as a computer program.

The hierarchical managing unit 11 specifies a sub-LUN (extracts a movement candidate) whose data is to be moved from the SSD 20 to the DIMM 30 by analyzing data access to sub-LUNs. Incidentally, various known methods may be used for the movement candidate extraction by the hierarchical managing unit 11, and description thereof will be omitted. The hierarchical managing unit 11 moves the data of a sub-LUN from the SSD 20 to the DIMM 30 or from the DIMM 30 to the SSD 20.

The hierarchical managing unit 11, for example, determines a sub-LUN for which region movement is to be performed based on collected IO access information, for example, based on information about IO traced for the SSD 20 or/and the DIMM 30, and instructs the hierarchical driver 12 to move the data of the determined sub-LUN.

As illustrated in FIG. 2, the hierarchical managing unit 11 has functions of a data collecting unit (collecting unit) 11a, a data movement determining unit 11b, and a movement instructing unit 11c.

The hierarchical managing unit 11 may, for example, be implemented as a dividing and configuration changing engine having three components of a Log Pool, work load analysis, and a sub-LUN movement instruction on Linux. Then, the components of the Log Pool, the work load analysis, and the sub-LUN movement instruction may respectively implement the functions of the data collecting unit 11a, the work load analyzing unit 11b, and the movement instructing unit 11c illustrated in FIG. 2.

The data collecting unit (collecting unit) 11a collects information (IO access information) about IO access to the SSD 20 or/and the DIMM 30.

For example, the data collecting unit 11a collects information about IO traced for the SSD 20 or/and the DIMM 30 using blktrace of Linux at given intervals (for example, at intervals of one minute). The data collecting unit 11a gathers information such, for example, as timestamp, logical block addressing (LBA), read/write (r/w), and length by the IO trace. A sub-LUN ID may be obtained from the LBA.

Here, blktrace is a command to trace IO at a block IO level. In the following, information about traced IO access may be referred to as trace information. Incidentally, the data collecting unit 11a may collect the IO access information using another method such, for example, as iostat, which is a command to check the usage state of disk IO, in place of blktrace. Incidentally, blktrace and iostat are executed in the OS space.

Then, the data collecting unit 11a counts the number of IO accesses for each sub-LUN based on the collected information.

For example, the data collecting unit 11a collects information about IO access in sub-LUN units at fixed time intervals (t). When the hierarchical managing unit 11 performs sub-LUN movement determination at intervals of one minute, for example, the fixed time intervals (t) are set to one minute.

The data collecting unit 11a also counts the read/write ratio (rw ratio) of IO to each segment or/and all segments or the ratio of write accesses to IO accesses (write ratio), and includes the rw ratio or the write ratio in the above-described information.

Thus, the data collecting unit 11a is an example of a collecting unit that collects information (data access information) about input IO access requests (data access requests) for a plurality of unit regions obtained by dividing the region used in the SSD 20 or the DIMM 30 in a given size.

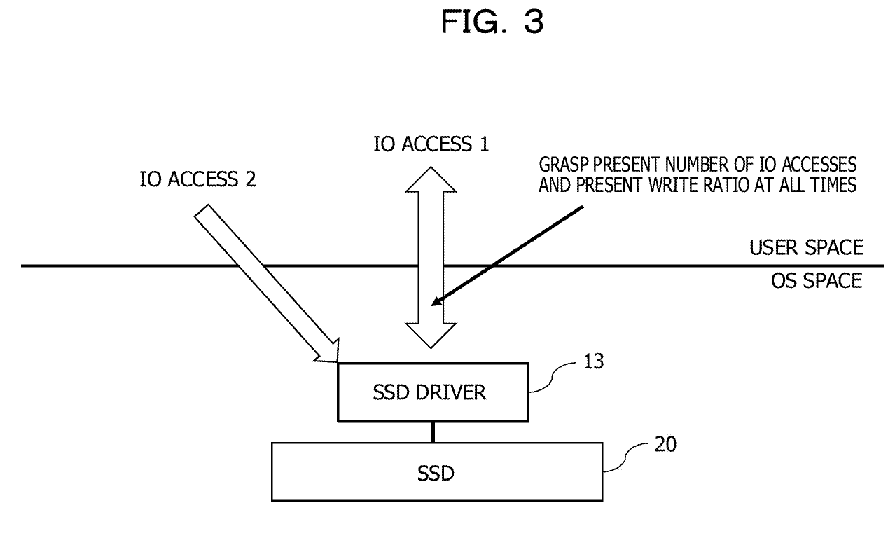

FIG. 3 is a diagram of assistance in explaining IO accesses to the SSD 20 in the hierarchical storage device 1 as an example of an embodiment. As illustrated in FIG. 3, IO access 1 (first IO access) and IO access 2 (second IO access) are made to the SSD 20.

Here, the IO access 1 is data access that occurs due to a request for read or write access to the SSD 20 from the application 3 executed in the host device 2.

The IO access 2 is data access that occurs due to a data write performed accompanying the movement (migration) of data from the DIMM 30 to the SSD 20 when the migration is performed.

The data collecting unit 11a monitors the number of IO accesses and the write ratio with regard to the IO access 1 at all times. For example, the data collecting unit 11a collects the number of IO accesses and the write ratio with regard to the IO access 1 at fixed time intervals (for example, one minute). The number of IO accesses and the write ratio correspond to the above-described data access information (the number of data accesses and the write ratio) about data accesses (IO access 1) to the first storage device (SSD 20) based on data access requests from the host device 2.

In addition, the data collecting unit 11a collects response times (access response times) from the SSD 20 with regard to the IO access 1. For example, when a threshold value updating unit 104 to be described later dynamically updates threshold value information 105, the data collecting unit 11a collects access response times with regard to the IO access 1 for a fixed time (for example, for one second).

The data collecting unit 11a notifies the collected access response times with regard to the IO access 1 to the data movement determining unit 11b (threshold value updating unit 104).

The movement instructing unit 11c instructs the hierarchical driver 12 to move the data of a selected sub-LUN from the SSD 20 to the DIMM 30 or move the data of the selected sub-LUN from the DIMM 30 to the SSD 20 according to an instruction (movement determination notification and movement object information) from the data movement determining unit 11b to be described later.

The data movement determining unit 11b selects a sub-LUN from which to move data in the SSD 20 or the DIMM 30 based on the IO access information collected by the data collecting unit 11a, and passes information about the selected sub-LUN to the movement instructing unit 11c.

A case where data is moved from the SSD 20 to the DIMM 30 in the present embodiment will be illustrated in the following.

As illustrated in FIG. 2, the data movement determining unit 11b includes a movement determining unit 101, a comparing unit 102, a suppressing unit 103, a threshold value updating unit 104, and threshold value information 105.

The movement determining unit 101 specifies a movement object region (sub-LUN) in the SSD 20, from which region data is to be moved to the DIMM 30, based on information (access information) about the number of IOs or the like, the information being collected by the data collecting unit 11a.

Various known methods may be used to specify the movement object region by the movement determining unit 101.

For example, the movement determining unit 101 may set a sub-LUN in which IO concentration continues for a given time (for example, three minutes) or more in the SSD 20 as an object for movement to the DIMM 30.

In addition, when a total number of IOs of a given number of sub-LUNs (maximum number of sub-LUNs) arranged in order of decreasing numbers of IOs exceeds a given IO ratio, a sub-LUN group including the maximum number of sub-LUNs may be set as a candidate for movement to the DIMM 30. Here, the IO ratio refers to a ratio represented in a total number of IOs. Further, when a sub-LUN set as a candidate for movement to the DIMM 30 becomes a movement candidate a given number of consecutive times or more, the sub-LUN may be determined as an object to be moved to the DIMM 30.

The movement determining unit 101 notifies a result of the determination to the movement instructing unit 11c to make the hierarchical driver 12 move the data of the sub-LUN as the determined object from the SSD 20 to the DIMM 30.

In addition, the movement determining unit 101, for example, moves the data of a region in which IO access does not occur for a given time in the DIMM 30 from the DIMM 30 to the SSD 20. Incidentally, a trigger for moving the data from the DIMM 30 to the SSD 20 is not limited to this, but may be modified in a various manners and implemented.

The movement determining unit 101 thus controls the execution of migration of data between the SSD 20 and the DIMM 30.

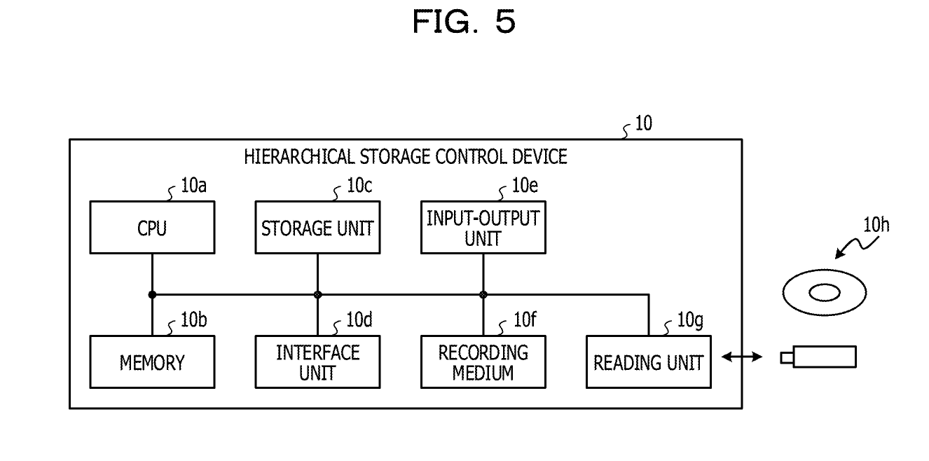

The threshold value information 105 is threshold values referred to when the comparing unit 102 to be described later performs comparison processing. In the present embodiment, an IO access number threshold value IO_TH and a write ratio threshold value W_TH are used as the threshold value information 105. The IO access number threshold value IO_TH and the write ratio threshold value W_TH are stored in a given storage region of a memory 10b or a storage unit 10c to be described later (see FIG. 5).

In addition, the IO access number threshold value IO_TH and the write ratio threshold value W_TH are updated by the threshold value updating unit 104 to be described later.

The comparing unit 102 compares the number of IO accesses with regard to the IO access 1, the number of IO accesses being collected by the data collecting unit 11a, with the IO access number threshold value IO_TH (first threshold value). In addition, the comparing unit 102 compares the write ratio with regard to the IO access 1, the write ratio being collected by the data collecting unit 11a, with the write ratio threshold value W_TH (second threshold value).

When the comparing unit 102 detects as a result of the comparison that the number of IO accesses exceeds the IO access number threshold value IO_TH and that the write ratio is below the write ratio threshold value W_TH, the comparing unit 102 provides a notification (detection notification) to the suppressing unit 103.

When the suppressing unit 103 receives the detection notification from the comparing unit 102, the suppressing unit 103 makes the movement determining unit 101 withhold the execution of movement (migration) of data from the SSD 20 to the DIMM 30. For example, when the comparing unit 102 detects that the number of IO accesses exceeds the IO access number threshold value IO_TH and that the write ratio is below the write ratio threshold value W_TH, the suppressing unit 103 withholds the execution of migration of data from the DIMM 30 to the SSD 20. The suppressing unit 103 withholds the execution of migration from the DIMM 30 to the SSD 20 by suppressing the execution of a data write (IO access 2) to the SSD 20, the data write accompanying the migration of data from the DIMM 30 to the SSD 20.

At this time, the suppressing unit 103 withholds the execution of the migration even when the movement determining unit 101 determines that the migration of data from the DIMM 30 to the SSD 20 is to be performed.

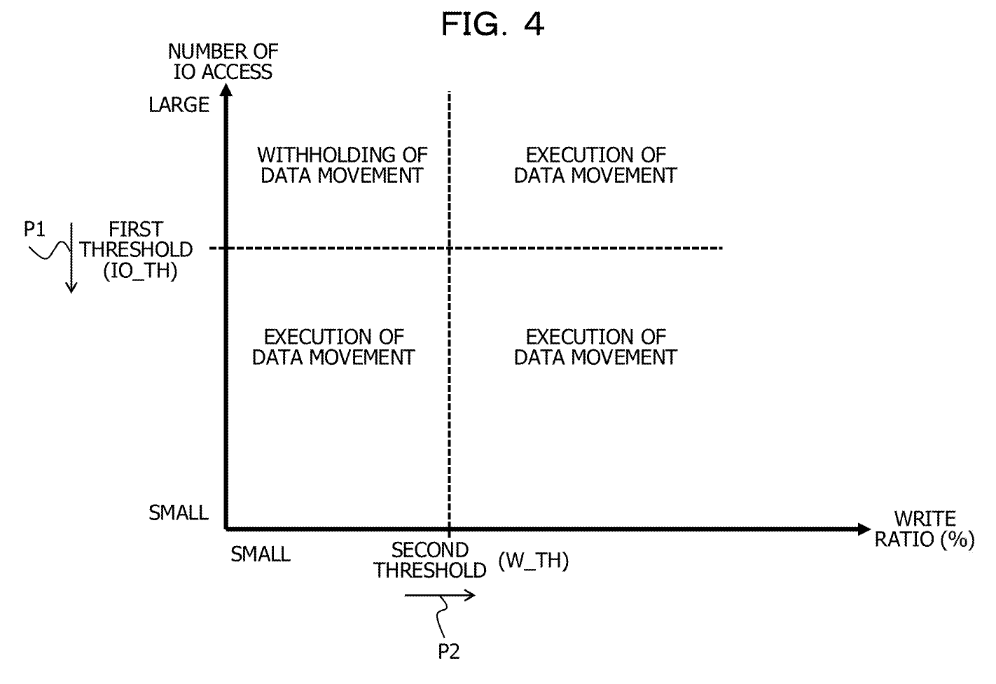

FIG. 4 is a diagram illustrating relation between the number of IO accesses, the write ratio, and the execution/withholding of data movement in the hierarchical storage device 1 as an example of an embodiment.

As illustrated in this FIG. 4, in the present hierarchical storage device 1, the data movement from the DIMM 30 to the SSD 20 is withheld when a condition (threshold value condition) that the number of IO accesses be larger than (exceed) a first threshold value (IO) access number threshold value IO_TH) and the write ratio be less than (below) a second threshold value (write ratio threshold value W_TH) is satisfied.

When the threshold value condition is not satisfied, on the other hand, the data movement from the DIMM 30 to the SSD 20 is performed without being suppressed.

The threshold value updating unit 104 updates the first threshold value (IO access number threshold value IO_TH) and the second threshold value (write ratio threshold value W_TH). The threshold value updating unit 104 performs processing of dynamically changing the IO access number threshold value IO_TH and the write ratio threshold value W_TH.

The threshold value updating unit 104 calculates an average response time of the IO access 1 to the SSD 20. Then, when data movement from the SSD 20 to the DIMM 30 (execution of the IO access 2) is performed, the threshold value updating unit 104 compares average response times of the IO access 1 before and after the execution of the data movement (IO access 2).

For example, the threshold value updating unit 104 obtains an average response time of the IO access 1 to the SSD 20 before the execution of the IO access 2. Suppose in the following that the average response time of the IO access 1 to the SSD 20 before the execution of the IO access 2 is an average response time A.

In addition, the threshold value updating unit 104 obtains an average response time of the IO access 1 to the SSD 20 after the execution of the IO access 2. Suppose in the following that the average response time of the IO access 1 to the SSD 20 after the execution of the IO access 2 is an average response time B.

The threshold value updating unit 104 updates the threshold values when the average response time of the IO access 1 after the execution of the data movement from the DIMM 30 to the SSD 20 is increased by a given threshold value (degradation determination threshold value) or more as compared with the average response time of the IO access 1 before the execution of the data movement. For example, the threshold value updating unit 104 updates the threshold values when IO access response performance is decreased (degraded) by a given value or more after the execution of the data movement as compared with IO access response performance before the execution of the data movement.

Incidentally, the threshold value (degradation determination threshold value) for detecting a degradation in the IO access response performance is set in advance. Suppose in the present embodiment that 10% (N=10), for example, is set in advance as the degradation determination threshold value.

The threshold value updating unit 104, for example, compares a difference (A−B) between the average response time B and the average response time A with the average response time A, and determines whether the difference (A−B) between the average response time B and the average response time A is within the degradation determination threshold value (N %) of the average response time A.

The threshold value updating unit 104 updates the IO access number threshold value IO_TH (first threshold value) and the write ratio threshold value W_TH (second threshold value) when the difference (A−B) between the average response time B and the average response time A is larger than the degradation determination threshold value (N %) of the average response time A, for example, when a degradation determination condition is satisfied.

When the threshold value updating unit 104 detects a degradation in the IO access response performance, the threshold value updating unit 104 changes the value of the IO access number threshold value IO_TH so as to reduce the value (see an arrow P1 in FIG. 4). In addition, when the threshold value updating unit 104 detects a degradation in the IO access response performance, the threshold value updating unit 104 changes the value of the write ratio threshold value W_TH so as to increase the value (see an arrow P2 in FIG. 4).

For example, the threshold value updating unit 104 updates the IO access number threshold value IO_TH by calculating the following Equation (1), and updates the write ratio threshold value W_TH by calculating Equation (2).

IO Access Number Threshold Value IO_TH=IO_TH−C (1)

Write Ratio Threshold Value W_TH=W_TH+D (2)

Incidentally, in the above Equation (1), C is a reduction range for updating the value of the IO access number threshold value IO_TH. The value of C is, for example, 100 (number of IOs). In addition, in the above Equation (2), D is an increase range for updating the value of the write ratio threshold value W_TH. The value of D is, for example, 5(%). The respective values of C and D are desirably set in advance.

The above Equations (1) and (2) change the IO access number threshold value IO_TH and the write ratio threshold value W_TH in a direction of expanding a region of “data movement withholding” in FIG. 4. For example, when detecting a degradation in the IO access response performance, the threshold value updating unit 104 changes the IO access number threshold value IO_TH and the write ratio threshold value W_TH so that the withholding of data movement from the DIMM 30 to the SSD 20 occurs more frequently (see the arrows P1 and P2 in FIG. 4). When the withholding of data movement from the DIMM 30 to the SSD 20 is performed more frequently, the response performance of the SSD 20 with regard to the IO access 1 may be improved.

In addition, the threshold value updating unit 104 calculates input output per second (IOPS) of the IO access 1 based on information about the IO access 1, the information being collected by the data collecting unit 11a.

Then, when the calculated value of IOPS with regard to the IO access 1 falls below a given threshold value α, the threshold value updating unit 104 performs processing of returning the IO access number threshold value IO_TH and the write ratio threshold value W_TH to respective initial values specified in advance.

Incidentally, the threshold value α is a value used as an index for determining whether a low-load state exists. A value of approximately 20 (IOPS), for example, is used as the threshold value α.

Returning to the description of FIG. 2, the movement instructing unit 11c instructs the hierarchical driver 12 to move the data of the selected sub-LUN from the SSD 20 to the DIMM 30 or to move the data of the selected sub-LUN from the DIMM 30 to the SSD 20 based on an instruction from the movement determining unit 101.

The hierarchical driver 12 assigns an IO request for a storage volume from a user to the SSD driver 13 or the DIMM driver 14, and returns an IO response from the SSD driver 13 or the DIMM driver 14 to the user (host device 2).

When the hierarchical driver 12 receives a sub-LUN movement instruction (segment movement instruction) from the movement instructing unit 11c, the hierarchical driver 12 performs movement processing of moving data stored in a movement object unit region in the DIMM 30 or the SSD 20 to the SSD 20 or the DIMM 30.

Incidentally, the data movement between the SSD 20 and the DIMM 30 by the hierarchical driver 12 may be realized by a known method, and description thereof will be omitted.

The SSD driver 13 controls access to the SSD 20 based on an instruction of the hierarchical driver 12. The DIMM driver 14 controls access to the DIMM 30 based on an instruction of the hierarchical driver 12.

[1-3] Example of Hardware Configuration of Hierarchical Storage Control Device

A hardware configuration of the hierarchical storage control device 10 illustrated in FIG. 2 will next be described with reference to FIG. 5. FIG. 5 is a diagram illustrating an example of a hardware configuration of the hierarchical storage control device 10 in the hierarchical storage device 1 as an example of an embodiment.

As illustrated in FIG. 5, the hierarchical storage control device 10 includes a CPU 10a, a memory 10b, a storage unit 10c, an interface unit 10d, an input-output unit 10e, a recording medium 10f, and a reading unit 10g.

The CPU 10a is an arithmetic processing device (processor) that is coupled to each of the corresponding blocks 10b to 10g and which performs various kinds of control and operation. The CPU 10a implements various functions in the hierarchical storage control device 10 by executing a program stored in the memory 10b, the storage unit 10c, the recording medium 10f or a recording medium 10h, a read only memory (ROM), which is not illustrated, or the like.

The memory 10b is a storage device that stores various kinds of data and programs. When the CPU 10a executes a program, the CPU 10a stores and expands data and the program in the memory 10b. Incidentally, the memory 10b includes, for example, a volatile memory such as a random access memory (RAM).

The storage unit 10c is hardware that stores various data and programs or the like. The storage unit 10c includes, for example, various kinds of devices including magnetic disk devices such as an HDD, semiconductor drive devices such as an SSD, and nonvolatile memories such as a flash memory. Incidentally, a plurality of devices may be used as the storage unit 10c, and these devices may constitute a redundant array of inexpensive disks (RAID). In addition, the storage unit 10c may be a storage class memory (SCM), and may include the SSD 20 and the DIMM 30 illustrated in FIG. 2.

The interface unit 10d performs control or the like of coupling and communication with a network (not illustrated) or another information processing device by wire or radio. The interface unit 10d includes, for example, adapters complying with a local area network (LAN), FC, and InfiniBand.

The input-output unit 10e may include at least one of an input device such as a mouse or a keyboard and an output device such as a display or a printer. The input-output unit 10e is, for example, used for various operations by a user, an administrator, or the like of the hierarchical storage control device 10.

The recording medium 10f is, for example, a storage device such as a flash memory or a ROM. The recording medium 10f may record various data and programs. The reading unit 10g is a device that reads data and programs recorded on the computer readable recording medium 10h. At least one of the recording media 10f and 10h may store a control program that implements all or a part of various kinds of functions of the hierarchical storage control device 10 according to the present embodiment. The CPU 10a may, for example, expand, in a storage device such as the memory 10b, the program read from the recording medium 10f or the program read from the recording medium 10h via the reading unit 10g, and execute the program. A computer (including the CPU 10a, an information processing device, and various kinds of terminals) may thereby implement functions of the above-described hierarchical storage control device 10.

Incidentally, the recording medium 10h includes, for example, flexible disks, optical disks such as a compact disc (CD), a digital versatile disc (DVD), and a Blu-ray Disk, and flash memories such as a universal serial bus (USB) memory, and a secure digital (SD) card. Incidentally, the CD includes a CD-ROM, a CD-recordable (R), and a CD-rewritable (RW). In addition, the DVD includes a DVD-ROM, a DVD-RAM, a DVD-R, a DVD-RW, a DVD+R, and a DVD+RW.

Incidentally, the above-described blocks 10a to 10g are mutually communicatably coupled to each other by a bus. For example, the CPU 10a and the storage unit 10c are coupled to each other via a disk interface. In addition, the above-described hardware configuration of the hierarchical storage control device 10 is illustrative. Hence, increasing or decreasing hardware (for example, addition or omission of arbitrary blocks), hardware division, hardware integration in arbitrary combinations, addition or omission of a bus, and the like within the hierarchical storage control device 10 may be performed as appropriate.

[2] Operation

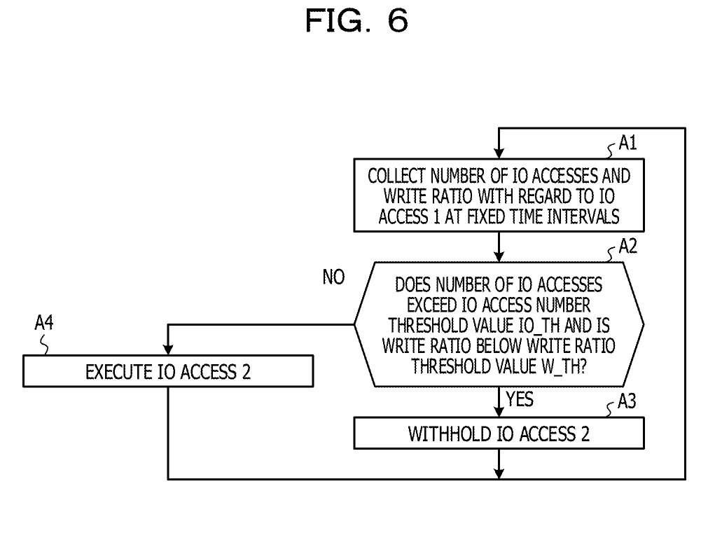

Processing by the hierarchical managing unit 11 of the hierarchical storage device 1 as an example of an embodiment configured as described above will first be described with reference to a flowchart (steps A1 to A4) of FIG. 6.

In step A1, the data collecting unit 11a collects the number of IO accesses and the write ratio with regard to the IO access 1 at fixed time intervals.

In step A2, the comparing unit 102 compares the number of IO accesses and the write ratio collected in step A1 with the respective threshold values.

For example, the comparing unit 102 compares the number of IO accesses collected by the data collecting unit 11a with the IO access number threshold value IO_TH (first threshold value). In addition, the comparing unit 102 compares the write ratio collected by the data collecting unit 11a with the write ratio threshold value W_TH (second threshold value).

When a result of the comparison indicates that the number of IO accesses exceeds the IO access number threshold value IO_TH and that the write ratio is below the write ratio threshold value W_TH (see a YES route in step A2), the processing proceeds to step A3.

In step A3, a detection notification is made from the comparing unit 102 to the suppressing unit 103, and the suppressing unit 103 withholds data movement (migration) from the SSD 20 to the DIMM 30. Thereafter, the processing returns to step A1.

When the result of the comparison in step A2 indicates that a condition that the number of IO accesses exceed the IO access number threshold value IO_TH and the write ratio be below the write ratio threshold value W_TH is not satisfied (see a NO route in step A2), on the other hand, the processing proceeds to step A4.

In step A4, the withholding of migration by the suppressing unit 103 is not performed, but the movement instructing unit 11c gives an instruction to perform migration of data from the SSD 20 to the DIMM 30 according to a determination result by the movement determining unit 101. For example, migration of data from the SSD 20 to the DIMM 30 is performed. Thereafter, the processing returns to step A1.

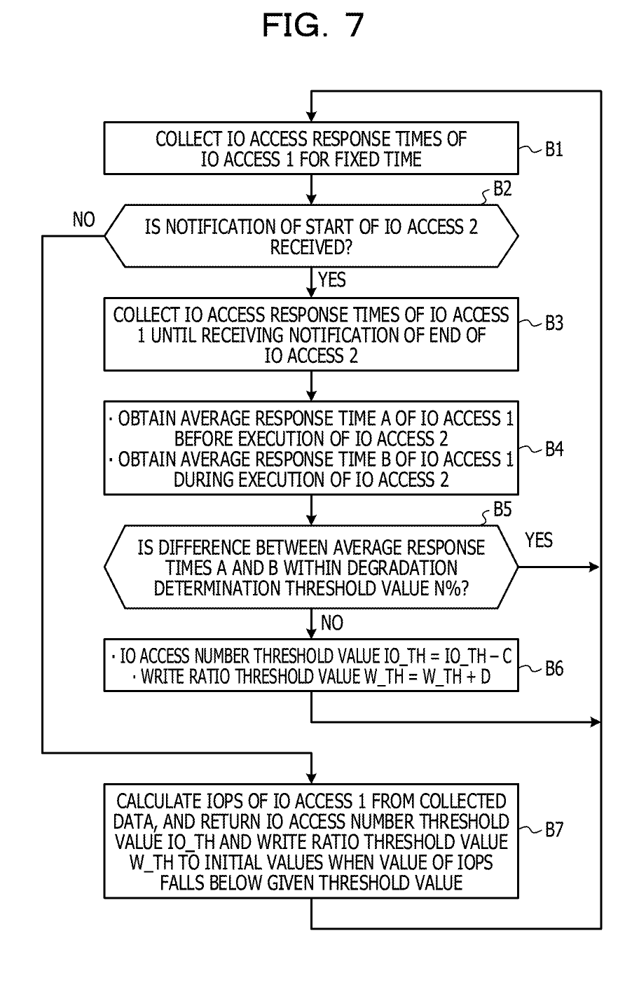

Threshold value update processing in the hierarchical storage device 1 as an example of an embodiment will next be described with reference to a flowchart (steps B1 to B7) of FIG. 7.

In step B1, the data collecting unit 11a collects access response times with regard to the IO access 1 for a fixed time (for example, for one second).

In step B2, the threshold value updating unit 104 checks whether a notification of a start of the IO access 2 is received from the hierarchical driver 12, for example. Incidentally, the IO access 2 is data access that occurs due to a data write performed at a time of migration of data from the DIMM 30 to the SSD 20.

When a result of the checking indicates that no notification of a start of the IO access 2 is received (see a NO route in step B2), the processing proceeds to step B7.

In step B7, the threshold value updating unit 104 calculates IOPS of the IO access 1 based on information about the IO access 1, the information being collected by the data collecting unit 11a. When the calculated value of IOPS with regard to the IO access 1 falls below the given threshold value α, the threshold value updating unit 104 performs processing of returning the IO access number threshold value IO_TH and the write ratio threshold value W_TH to the respective initial values. Thereafter, the processing returns to step B1.

When the result of the checking in step B2 indicates that a notification of a start of the IO access 2 is received (see a YES route in step B2), the processing proceeds to step B3.

In step B3, the threshold value updating unit 104 collects IO access response times of the IO access 1 until receiving a notification of an end of the IO access 2.

In step B4, the threshold value updating unit 104 calculates an average (average response time A) of the IO access response times of the IO access 1 before the execution of the IO access 2. The threshold value updating unit 104 also calculates an average (average response time B) of the IO access response times of the IO access 1 during the execution of the IO access 2.

In step B5, the threshold value updating unit 104 compares the average response time A and the average response time B with each other, and checks whether a difference between the average response time A and the average response time B is within the degradation determination threshold value N (%).

When a result of the checking in step B5 indicates that the difference between the average response time A and the average response time B is within the degradation determination threshold value N (%) (see a YES route in step B5), the processing returns to step B1.

When the result of the checking in step B5 indicates that the difference between the average response time A and the average response time B is larger than the degradation determination threshold value N (%) (see a NO route in step B5), on the other hand, the processing proceeds to step B6.

When the difference between the average response time A and the average response time B is larger than the degradation determination threshold value N (%), it is considered that a load on the SSD 20 is increased by the execution of the IO access 2, and that response performance for the IO access 1 is thereby decreased.

In the present hierarchical storage device 1, the threshold value updating unit 104 changes the IO access number threshold value IO_TH and the write ratio threshold value W_TH such that the withholding of data movement from the DIMM 30 to the SSD 20 occurs more frequently. Consequently, more frequent withholding of data movement from the DIMM 30 to the SSD 20 reduces the load due to the IO access 2, and improves processing performance for the IO access 1.

In step B6, the threshold value updating unit 104 updates the threshold value information 105 using the above-described Equations (1) and (2). For example, the threshold value updating unit 104 updates the IO access number threshold value IO_TH by calculating IO Access Number Threshold Value IO_TH=IO_TH−C. In addition, the threshold value updating unit 104 updates the write ratio threshold value W_TH by calculating Write Ratio Threshold Value W_TH=W_TH+D. Thereafter, the processing returns to step B1.

[3] Effect

Thus, according to the hierarchical storage device 1 as an example of one embodiment, the data collecting unit 11a collects the number of IO accesses and the write ratio with regard to the IO access 1 occurring due to a read or a write performed on the SSD 20 from the application 3 of the host device 2.

Then, the comparing unit 102 compares the collected number of IO accesses with the IO access number threshold value IO_TH, and compares the collected write ratio with the write ratio threshold value W_TH.

When a result of the comparison indicates that the number of IO accesses exceeds the IO access number threshold value IO_TH and that the write ratio is below the write ratio threshold value W_TH, the suppressing unit 103 withholds data movement (migration) from the SSD 20 to the DIMM 30.

Thus, the IO access 1 from the host device 2 may be processed while given a higher priority than the IO access 2 due to migration. Therefore IO access performance for the host 2 may be maintained without being affected by migration.

The threshold value updating unit 104 dynamically changes the IO access number threshold value IO_TH and the write ratio threshold value W_TH when the average response time of the IO access 1 after the execution of data movement from the DIMM 30 to the SSD 20 is increased by a given threshold value (degradation determination threshold value) or more as compared with the average response time of the IO access 1 before the execution of the data movement.

For example, when a degradation in IO access response performance is detected, the threshold value updating unit 104 changes the IO access number threshold value IO_TH and the write ratio threshold value W_TH such that the withholding of data movement from the DIMM 30 to the SSD 20 occurs more frequently. Thus, more frequently withholding data movement from the DIMM 30 to the SSD 20 may reduce a load due to the IO access 2, and improves response performance of the SSD 20 with regard to the IO access 1.

[4] Others

The disclosed technology is not limited to the foregoing embodiments, but may be modified in various manners and carried out without departing from the spirit of the present embodiments.

For example, in one embodiment, description has been made of the hierarchical storage device 1 using the SSD 20 and the DIMM 30. However, without limitation to this, the present technology may also be similarly applied to a hierarchical storage system using a cache memory and a main storage device, for example. For example, the present technology is similarly applicable not only to hierarchical storage systems of nonvolatile storage devices but also to hierarchical storage systems including a volatile storage device.

In addition, the hierarchical storage device 1 according to one embodiment may be applied also to storage devices having speeds different from each other as well as to the SSD 20 and the DIMM 30. For example, the hierarchical storage device 1 may also be applied as a hierarchical storage device or the like using the SSD 20 and an HDD having a lower access speed than the SSD. In addition, the hierarchical storage device 1 may also be applied as a hierarchical storage device or the like using the SSD 20 and a magnetic recording device such as a tape drive having a higher capacity than the SSD but having a lower speed than the SSD.

Further, in one embodiment, the operation of the hierarchical storage control device 10 has been described while attention is directed to one SSD 20 and one DIMM 30. However, similar operation is performed also in a case where a plurality of SSDs 20 and a plurality of DIMMs 30 are included in the hierarchical storage device 1.

In addition, in the foregoing embodiments, an example has been illustrated in which the hierarchical storage control device 10 uses functions of the Linux device-mapper or the like, but is not limited to this. For example, functions of another volume managing driver or another OS may be used, and the foregoing embodiments may be modified in various manners and carried out.

In addition, the functional blocks of the hierarchical storage control device 10 illustrated in FIG. 2 may each be integrated in arbitrary combinations or divided.

In addition, description has been made supposing that the data movement determining unit 11b determines a movement object region in a sub-LUN (segment) unit, and gives an instruction for hierarchical movement to the movement instructing unit 11c. However, there is no limitation to this.

For example, a movement object region specified by the data movement determining unit 11b may be a region obtained by linking together regions in the vicinity of a high-load region. In this case, the data movement determining unit 11b may notify the movement instructing unit 11c of, for example, information indicating a segment ID or offset range as information about movement object segments. Incidentally, it suffices for the movement instructing unit 11c to issue a movement instruction to the hierarchical driver 12 for each of the plurality of sub-LUNs included in the notified range.

In the foregoing embodiments, description has been made of a case where the data movement determining unit 11b is provided with the functions of the movement determining unit 101, the comparing unit 102, the suppressing unit 103, and the threshold value updating unit 104 and the threshold value information 105. However, there is no limitation to this. It suffices to provide the functions of the movement determining unit 101, the comparing unit 102, the suppressing unit 103, and the threshold value updating unit 104 and the functions of the threshold value information 105 within the hierarchical managing unit 11.

In addition, in the foregoing embodiments, description has been made of a case where the present technology is applied to a hierarchical storage. However, there is no limitation to this. The present technology is similarly applied as in the foregoing embodiments to a case where the first storage device such as a DIMM is a cache memory, and action and effect similar to those of the foregoing embodiments may be obtained.

In addition, the present embodiments may be carried out and manufactured by those skilled in the art based on the above-described disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a first memory;
a second memory; and
a processor coupled to the first memory and the second memory, the processor being configured to:
obtain access information about a number of times of data accesses including write accesses and read accesses, the data accesses being made to the first memory from another information processing device,
perform processing of migration of data between the first memory and the second memory, and
stop execution of the processing of the migration of the data from the second memory to the first memory when the number of times of data accesses per unit time is more than a first value and a ratio of the write accesses to the data accesses is less than a second value.

2. The information processing device according to claim 1, wherein
a first access speed from the another information processing device to the first memory is higher than a second access speed from the another information processing device to the second memory.

3. The information processing device according to claim 1, wherein
the processor is configured to:
change the first value and the second value when a difference between the first access speed before the execution of the processing of the migration of the data and the first access speed after the execution of the processing of the migration of the data is equal to or more than a third value.

4. The information processing device according to claim 1, wherein
the processor is configured to:
resume the execution of the processing of the migration of the data from the second memory to the first memory when the number of accesses becomes equal to or less than the first value.

5. The information processing device according to claim 1, wherein
the processor is configured to:
resume the execution of the processing of the migration of the data from the second memory to the first memory when the ratio of the write accesses to the data accesses becomes equal to or more than the second value.

6. A control device configured to control a processing of migration of data between a first memory and a second memory information processing device, the control device comprising:
a processor coupled to the first memory and the second memory, the processor being configured to:
obtain access information about a number of times of data accesses including write accesses and read accesses, the data accesses being made to the first memory from another information processing device,
perform the processing of migration of data between the first memory and the second memory, and
stop execution of the processing of the migration of the data from the second memory to the first memory when the number of times of data accesses per unit time is more than a first value and a ratio of the write accesses to the data accesses is less than a second value.

7. The control device according to claim 6, wherein
a first access speed from the another information processing device to the first memory is higher than a second access speed from the another information processing device to the second memory.

8. The control device according to claim 6, wherein
the processor is configured to:
change the first value and the second value when a difference between the first access speed before the execution of the processing of the migration of the data and the first access speed after the execution of the processing of the migration of the data is equal to or more than a third value.

9. The control device according to claim 6, wherein
the processor is configured to:
resume the execution of the processing of the migration of the data from the second memory to the first memory when the number of accesses becomes equal to or less than the first value.

10. The control device according to claim 6, wherein
the processor is configured to:
resume the execution of the processing of the migration of the data from the second memory to the first memory when the ratio of the write accesses to the data accesses becomes equal to or more than the second value.

11. A method of controlling a processing of migration of data between a first memory and a second memory information processing device, the method comprising:
obtaining access information about a number of times of data accesses including write accesses and read accesses, the data accesses being made to the first memory from another information processing device;
performing the processing of migration of data between the first memory and the second memory; and
stopping execution of the processing of the migration of the data from the second memory to the first memory when the number of times of data accesses per unit time is more than a first value and a ratio of the write accesses to the data accesses is less than a second value.

12. The method according to claim 11, wherein
a first access speed from the another information processing device to the first memory is higher than a second access speed from the another information processing device to the second memory.

13. The method according to claim 11 further comprising:
changing the first value and the second value when a difference between the first access speed before the execution of the processing of the migration of the data and the first access speed after the execution of the processing of the migration of the data is equal to or more than a third value.

14. The method according to claim 11 further comprising:
resuming the execution of the processing of the migration of the data from the second memory to the first memory when the number of accesses becomes equal to or less than the first value.

15. The method according to claim 11 further comprising:
resuming the execution of the processing of the migration of the data from the second memory to the first memory when the ratio of the write accesses to the data accesses becomes equal to or more than the second value.
